(19) United States
(12) Patent Application Publication
(10) Pub. No.: US 2014/0347413 A1
(43) Pub. Date: Nov. 27, 2014

(54) PRINTING DEVICE

(71) Applicant: SEIKO Precision Inc., Narashino-shi, Chiba (JP)

(72) Inventor: Koji Ehara, Narashino-shi (JP)

(21) Appl. No.: 14/368,157

(22) PCT Filed: Dec. 28, 2012
(86) PCT No.: PCT/JP2012/084226

§ 371 Date: Jun. 23, 2014

(30) Foreign Application Priority Data
Jan. 23, 2012 (JP) 2012-010979

(51) Int. Cl. B41J 25/308

(52) U.S. Cl. CPC B41J 25/308
USPC 347/8

(57) ABSTRACT

The time recorder comprises a casing comprising gears (428) rotatably supported by the casing and a motor rotating the gears (428); a printing unit provided within the casing and comprising a carriage (210) provided slidably in the X-direction and comprising a print head (213) and longitudinal racks (420) extending in the Y-direction and intermeshing with the gears (428); and a controller controlling the motor. As the motor runs according to the control of the controller, the gears (428) rotate and the printing unit (20) moves in the Y-direction.

### TECHNICAL FIELD

The present invention relates to a printing device.

### BACKGROUND ART

The inkjet printer disclosed in Patent Literature 1 comprises a print head having multiple nozzles, and a head maintainer maintaining the print head. The print head is movable in the direction connecting the position where the print head faces the print medium and the position where the print head is attached to the head maintainer (the horizontal direction).

### CITATION LIST

### Patent Literature

Patent Literature 1: Unexamined Japanese Patent Application Kokai Publication No. 2008-55734.

### SUMMARY OF INVENTION

### Technical Problem

When the print head does not move in the print medium feed direction as in the inkjet printer disclosed in the Patent Literature 1, the print medium should be moved in the feed direction so that the print head faces the entire print surface. For example, the print medium should be movable on a plane facing the print head. In such a case, the space necessary for printing is approximately double the print medium in longitudinal dimension. For that reason, the inkjet printer itself has a longitudinal dimension nearly double the print medium, which hampers downsizing.

The present invention is invented with the view of the above problem and an exemplary objective of the present invention is to downsize a printing device.

### Solution to Problem

In order to achieve the above objective, the print device according to the present invention comprises: a casing comprising first gears rotatably supported by the casing and a motor rotating the first gears; a printing unit provided within the casing and comprising a carriage provided slidably in a first direction and comprising a print head and second-direction racks extending in the second direction perpendicular to the first direction and to the print direction and intermeshing with the first gears; and a controller controlling the motor.

Furthermore, it is possible that: the printing unit comprises a rotation shaft extending in the first direction, the first gears are fixed to both ends of the rotation shaft coaxially, the second-direction racks are provided on both sides of the printing unit in the first direction and intermesh with the first gears, respectively, and the motor rotates the rotation shaft so as to rotate the first gears.

Furthermore, it is possible that: the printing unit has elongated holes at both ends that are formed through in the first direction and of which the longitudinal direction coincides with the second direction, and the rotation shaft is provided through the elongated holes.

Furthermore, it is possible that: the rotation shaft is fixed to one gear in a gear group comprising multiple intermeshing gears, and the motor rotates the input gear that is another gear in the gear group so as to rotate the rotation shaft.

Furthermore, it is possible that: the printing unit comprises a reeler comprising a reeling-up rack extending in the first direction, reeling-up gears intermeshing with the reeling-up rack and rotating as the carriage moves in the first direction, and a reeling-up shaft reeling up the ink ribbon of the printing head as the reeling-up gears rotate, and the reeler is mounted in the casing movably in the print direction in one piece with the print head.

It is possible that the printing device comprises: a guide formed on one of the printing unit and casing and extending in the direction perpendicular to the print direction; a gap adjustment member comprising a central shaft supported by the other of the printing unit and casing and an eccentric shaft provided with its shaft center shifted from the central shaft and moving as guided by the guide; and a fixing member fixing the gap adjustment member to the casing so that the gap adjustment member is not rotatable.

### Advantageous Effects of Invention

The present invention can downsize a printing device.

### BRIEF DESCRIPTION OF DRAWINGS

FIG. 1 is a partially-cutaway perspective view showing the printing device according to the embodiment;

FIG. 2 is a partially-cutaway perspective view showing the printing device according to the embodiment;

FIG. 3 is a perspective view showing the printing unit;

FIG. 4 is a perspective view showing the underside of the printing unit;

FIG. 5 is an enlarged perspective view showing the ribbon reeling-up gears and ribbon reeling-up gear rack;

FIG. 6 is a perspective view schematically showing the print gap adjuster;

FIG. 7 is a side view schematically showing the motion of the print gap adjuster;

FIG. 8 is a perspective view schematically showing the print gap adjuster according to Modified Embodiment 1;

FIG. 9 is a side view schematically showing the motion of the print gap adjuster according to Modified Embodiment 1; and

FIG. 10 is a perspective view schematically showing the print gap adjuster according to Modified Embodiment 2.

### DESCRIPTION OF EMBODIMENTS

An embodiment of the printing device according to the present invention will be described hereafter using a time recorder by way of example and with reference to the attached drawings.

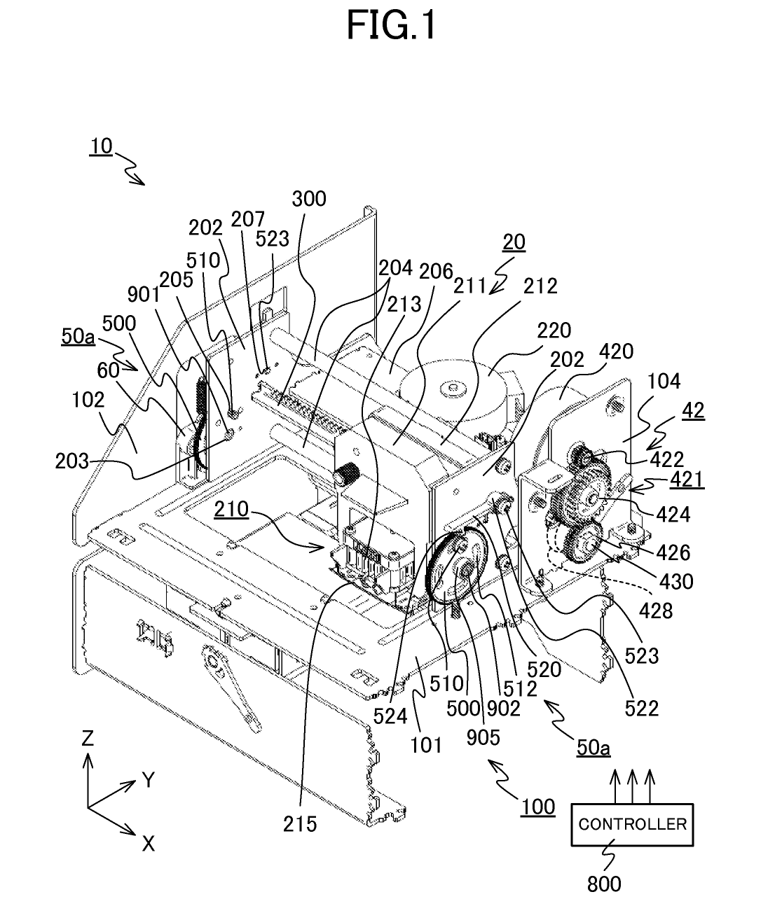

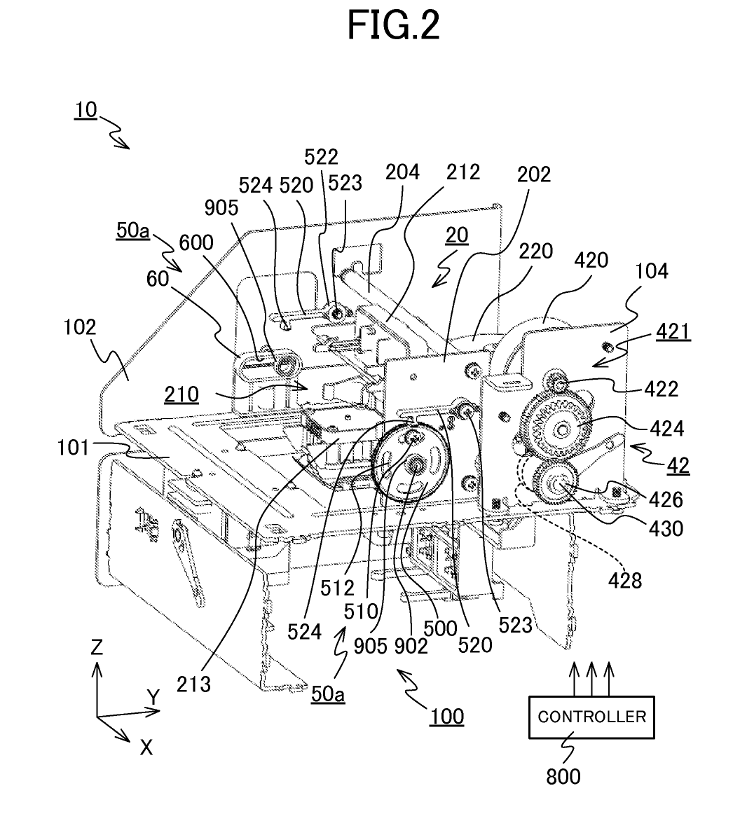

A time recorder 10 according to an embodiment of the present invention is a dot impact printing device comprising, as shown in FIGS. 1 and 2, a casing 100, a printing unit 20, a print gap adjuster 50a adjusting the space between the casing 100 and printing unit 20, a longitudinal driver 42 driving the printing unit 20 in the longitudinal direction, and a controller 800.

For easier understanding, the following explanation will be made on the assumption of the X-, Y-, and Z-directions orthogonal to each other. As for the X-, Y-, and Z-directions shown in the figures, the directions with a sign “+” refer to the arrowed directions, the directions with a sign “−” refer to the directions opposite to the arrowed directions, and the directions with no sign refer to both directions. The X-direction corresponds to the moving direction of a carriage 210 described later and is also referred to as the horizontal direction (and the first direction). The Y-direction corresponds to the transfer direction of the print sheet and the direction opposite to the transfer direction and is also referred to as the longitudinal direction (and the second direction). The Z-direction corresponds to the direction in which a print head 213 described later moves closer to or away from a lower casing frame (platen) 101 and is also referred to as the vertical direction. The above components constituting the time recorder 10 will be described in detail hereafter.

The casing 100 comprises a plate-like lower casing frame 101, two plate-like first lateral casing frames 102 fixed to both ends of the lower casing frame 101, and a plate-like second lateral casing frame 104 provided between the first lateral casing frame 102 on the +X side (one side) and a lateral block frame 202 described later on the +X side. The lower casing frame 101 is parallel to the X-Y plane. The two first lateral casing frames 102 and second lateral casing frame 104 are parallel to the Y-Z plane and protrude from the lower casing frame 101 upward (in the +Z direction).

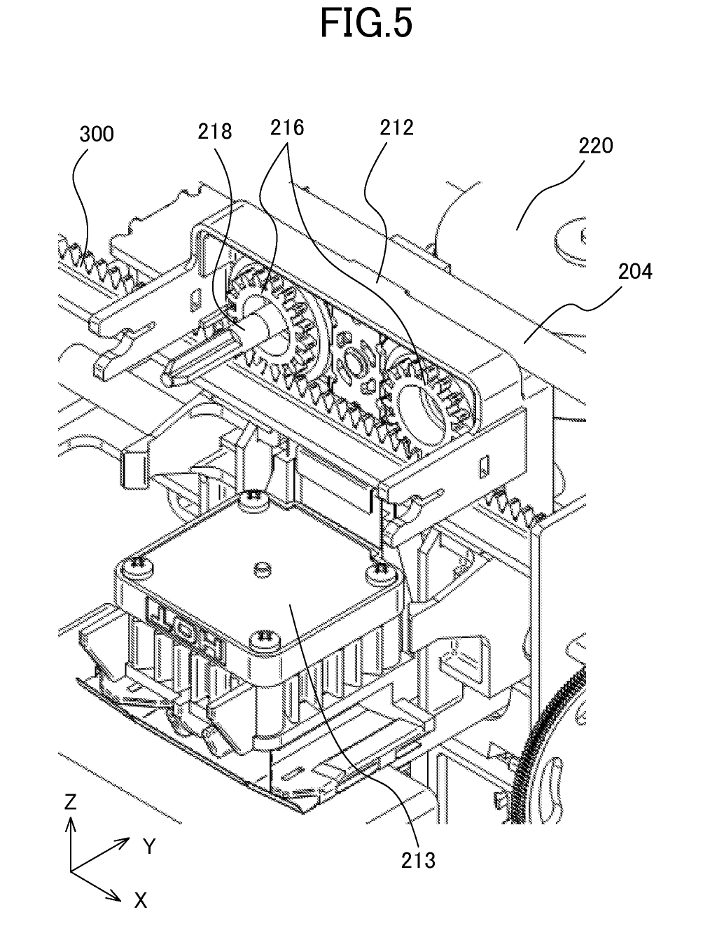

In FIGS. 1 and 2, the first lateral casing frame 102 on the +X side is omitted to show the internal structure within the casing 100. Furthermore, in FIGS. 2 and 5, an ink ribbon cartridge 211 is removed from a cartridge mount 212. Furthermore, in FIG. 2, a guide roller mounting gear 500, a lateral block frame 202, and a ribbon reeling-up gear rack 300 on the −X side are omitted to show a guide 60.

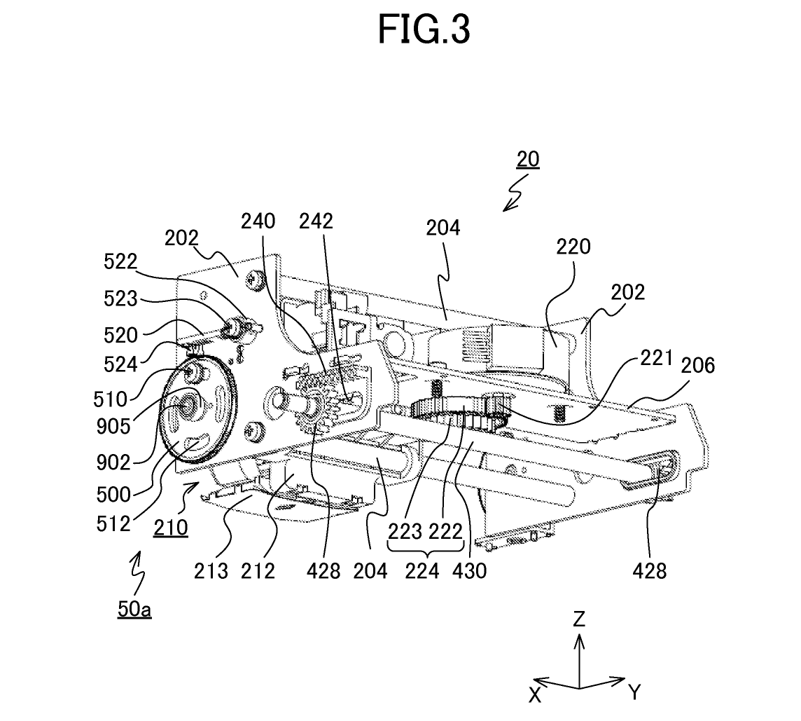

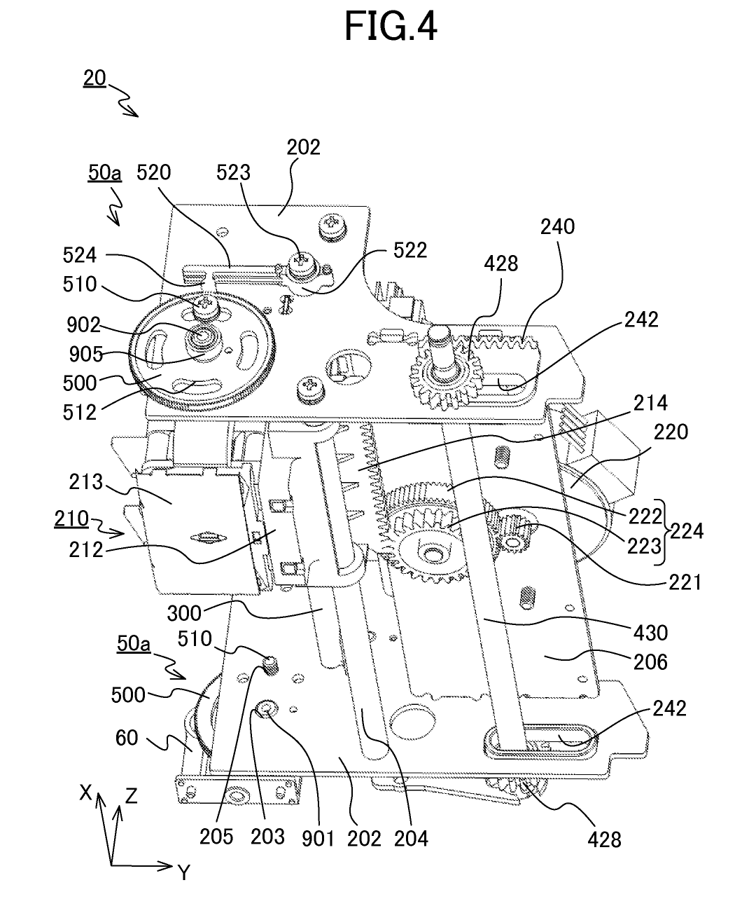

The printing unit 20 comprises, as shown in FIGS. 3 and 4, two plate-like lateral block frames 202, two X-direction guide rods 204 extending between the two lateral block frames 202 and each fixed thereto at the ends, a carriage 210 having ribbon reeling-up gears 216 (see FIG. 5) and supported and guided in the horizontal direction (X-direction) by the X-direction guide rods 204, and a ribbon reeling-up gear rack 300 (see FIG. 5) intermeshing with the ribbon reeling-up gears 216.

The two lateral block frames 202 extend in parallel to the Y-Z plane, are nearly parallel to each other, and each have a through-hole 203 (see FIG. 1) supporting a central shaft 901 described later, a female screw hole 205 (see FIG. 1) in which a fixing screw 510 described later is screwed, and a female screw hole 207 in which a screw 523 described later is screwed. A guide roller mounting gear 500 constituting a part of the print gap adjuster 50a is provided on the surface of each lateral block frame 202 that faces the first lateral casing frame 102, and the central shaft 901 formed on the guide roller mounting gear 500 is rotatably supported by the hole 203. The hole 203 is not limited to a through-hole and can be a recess-like hole as long as the hole 203 can rotatably support the guide roller mounting gear 500.

Furthermore, a longitudinal rack (second-direction rack, see FIGS. 3 and 4) 240 intermeshing with a gear (first gear) 428 described later is formed along the Y-direction on the outer surface of the two lateral block frames 202 (the surface on which the guide roller mounting gear 500 is provided). As the gear 428 described later rotates (forward or backward), the printing unit 20 moves in the Y-direction via the longitudinal rack 240 intermeshing with the gear 428.

Furthermore, the lateral block frames 202 each has an elongated hole 242. The elongated hole 242 is formed along the Y-direction (the longitudinal direction thereof coincides with the Y-direction) on the −Z side of the longitudinal rack 240, having a width slightly larger than the diameter of a rotation shaft 430 described later and a length nearly equal to the length of the longitudinal rack 240. The rotation shaft 430 described later is inserted in the two elongated holes 242. The elongated holes 242 are longer than the amount of longitudinal displacement of the printing unit 20. Therefore, the front and rear edges of the elongated holes 242 do not abut against the rotation shaft 430 as the printing unit 20 moves in the longitudinal direction, whereby there is no interference with the rotation of the rotation shaft 430 (the longitudinal movement of the printing unit 20).

The X-direction guide rods 204 serve as a guide for moving a carriage 210 described later in the X-direction. The X-direction guide rods 204 extend in the X-direction and are provided in parallel in the Z-direction. The ends of the X-direction guide rods 204 are fixed to the two lateral block frames 202, respectively. The carriage 210 (the cartridge mount 212 thereof) is clamped from above and below and supported slidably in the X-direction by the two X-direction guide rods 204.

The ribbon reeling-in gear rack 300 extends between the two lateral block frames 202 in parallel to the X-direction guide rods 204 (in the X-direction) and are fixed thereto at the ends. The ribbon reeling-in gear rack 300 intermeshes with ribbon reeling-in gears 216 described later.

The carriage 210 comprises an ink ribbon cartridge 211 incorporating an ink ribbon (not shown), a cartridge mount 212 on which the ink ribbon cartridge 211 is mounted, and a print head 213 provided below the ink ribbon cartridge 211 (on the −Z side).

The cartridge mount 212 comprises ribbon reeling-in gears 216, a ribbon reeling-in shaft 218, and an X-direction rack 214 provided in parallel to the side face on the +Y side (in parallel to the X-direction guide rods 204) and extending in the X-direction.

The ribbon reeling-in gears 216 are rotatably supported by the cartridge mount 212, intermesh with the ribbon reeling-in gear rack 300, and rotate as the carriage 210 moves in the horizontal direction (X-direction). As the ribbon reeling-in shaft 218 rotates along with the rotation of the ribbon reeling-in gears 216, the ink ribbon incorporated and wound in the ink ribbon cartridge 211 is pulled out.

Furthermore, the X-direction rack 214 intermeshes with a two-step gear 224 described later. As the two-step gear 224 rotates forward or backward, the X-direction rack 214 makes the carriage 210 move in the X-direction.

The printing unit 20 further comprises a two-step gear 224 intermeshing with the X-direction rack 214 and a motor 220 rotating a pinion 221 intermeshing with the two-step gear 224 for moving the carriage 210 in the X-direction.

The motor 220 is mounted and fixed on a mounting plate 206 extending between the lateral block frames 202 and rotates its rotation shaft according to the control of the controller 800. The pinion 221 is fixed to the rotation shaft of the motor 220. The pinion 221 protrudes below the mounting plate 206.

The two-step gear 224 is formed as an integrated piece of a small gear 223 and a large gear 222 and rotatably supported by the mounting plate 206. The large gear 222 intermeshes with the pinion 221 and the small gear 223 intermeshes with the X-direction rack 214.

The controller 800 comprises a microprocessor, a motor driver circuit, and the like, and rotates the motor 220 and a motor 420 described later according to the control program.

(Horizontal Movement of the Carriage 210)

The carriage 210 moves in the horizontal direction as the motor 220 runs according to the control of the controller 800. More specifically, the carriage 210 moves as follows.

According to the control of the controller 800, the rotation shaft of the motor 220 rotates either forward or backward. First, as the rotation shaft of the motor 220 rotates forward (the rotation direction causing the pinion 221 to rotate clockwise in FIG. 4), the two-step gear 224 (the large gear 222) intermeshing with the pinion 221 rotates backward. Here, the rotation speed of the two-step gear 224 rotating due to the rotative power being reduced because of the difference in diameter (the number of teeth) between the pinion 221 and large gear 222. The small gear 223 integrated with the large gear 222 rotates as well. Since the small gear 223 and X-direction rack 214 intermesh with each other, the rotative power of the small gear 223 is converted to the motive power to move the carriage 210 in the −X direction. In this way, as the rotation shaft of the motor 220 rotates forward, the carriage 210 moves in the −X direction.

On the other hand, as the rotation shaft of the motor 220 rotates backward (the rotation direction causing the pinion 221 to rotate counterclockwise in FIG. 4), the two-step gear 224 (the large gear 222) intermeshing with the pinion 221 rotates forward. Here, the rotation speed of the two-step gear 224 rotating due to the rotative power being reduced because of the difference in diameter between the pinion 221 and large gear 222. The small gear 223 integrated with the large gear 222 rotates as well in one piece. Since the small gear 223 and X-direction rack 214 intermesh with each other, the rotative power of the small gear 223 is converted to the motive power to move the carriage 210 in the +X direction. In this way, as the rotation shaft of the motor 220 rotates backward, the carriage 210 moves in the +X direction.

(Print Gap Adjuster 50a)

The print gap adjuster 50a has the function of adjusting the space (print gap) between the casing 100 (lower casing frame 101) and printing unit 20 and is provided to the right and to the left of the printing unit 20 one each. The print gap adjuster 50a is provided to adjust the space between the print medium and the print head 213 based on the dimensional tolerance and/or assembly tolerance of the components of the time recorder 10 at the factory so as to assure a given print quality. The print gap adjuster 50a comprises the aforementioned lateral block frame 202, which is a part of the printing unit 20, a guide roller mounting gear 500, a guide 60 fixed on the lower casing frame 101, and a gear fixing rack 520. The components of the print gap adjuster 50a will be described in detail hereafter.

The guide roller mounting gear 500 is a spur gear with multiple spur teeth on the circumference, having a central shaft 901 in the shape of a protrusion formed at the center of rotation and protruding from the first surface (the surface facing the lateral block frame 202), an eccentric protrusion 902 formed at a position shifted from the center of rotation (an eccentric position) and protruding from the second surface (the surface facing the first lateral casing frame 102), and four arc-shaped elongated holes 512 provided evenly on a concentric circle around the central shaft 901. The spur teeth are formed for setting the minimum adjustment amounts of the height and inclination of the printing unit 20 with respect to the casing 100. The spur teeth intermesh with the leading end 524 of a gear fixing rack 520 described later.

With the central shaft 901 being inserted in the hole 203, the guide roller mounting gear 500 is supported by the lateral block frame 202 (the printing unit 20 including it) rotatably about the hole 203. A guide roller 905 is rotatably supported around the eccentric protrusion 902. The eccentric protrusion 902 and guide roller 905 are housed in a guide groove 600 of the guide 60 described later. Upon print gap adjustment described later, the guide roller 905 is supported by the guide groove 600 slidably in the Y-direction and abuts against the edges of the guide groove 600 in the Z-direction to move the printing unit 20 up or down. Furthermore, when the printing unit 20 moves in the Y-direction, the guide roller 905 makes sliding contact with the guide groove 600; then, the printing unit 20 moves in the Y-direction smoothly while maintaining its height in the Z-direction. Furthermore, with a fixing screw 510 being inserted in the elongated hole 512 after print gap adjustment described later, the guide roller mounting gear 500 is fixed to the lateral block frame 202.

The guide 60 has a guide groove 600 in the shape of an elongated hole and is fixed on the top surface of the lower casing frame 101 with the longitudinal direction of the guide groove 600 coinciding with the Y-direction. Upon print gap adjustment described later, the edges of the guide groove 600 make sliding contact with the guide roller 905 in the Z-direction; then, the guide 60 has the function of defining the print gap. Furthermore, when a longitudinal driver 42 described later drives the printing unit 20 in the longitudinal direction, the guide 60 guides the printing unit 20 so that printing unit 20 moves in the longitudinal direction nearly in parallel to the lower casing frame 101. The longitudinal width of the guide groove 600 is sufficiently larger than the longitudinal moving range of the printing unit 20 so that the guide groove 600 does not interfere with the longitudinal movement of the printing unit 20.

The gear fixing rack 520 is made of an elastic material and has a base end 522 and a leading end 524 having a rack intermeshing with the teeth of the guide roller mounting gear 500. The pitch of multiple protrusions (grooves) formed on the rack is equal to the pitch of the grooves (teeth) of the guide roller mounting gear 500. The base end 522 of the gear fixing rack 520 is fixed on (supported by) the outer surface of the lateral block frame 202. For this support, a screw 523 passing through the base end 522 of the gear fixing rack 520 is screwed in a female screw hole 207 formed in the lateral block frame 202. The gear fixing rack 520 exerts its elastic force (restoring force) to keep the leading end 524 intermeshing with the teeth of the guide roller mounting gear 500.

Since the rotation angle is determined based on the teeth of the guide roller mounting gear 500 intermeshing with the gear fixing rack 520, the minimum set quantity of rotation angle of the guide roller mounting gear 500 is one tooth pitch. Therefore, the minimum set quantity of rotation angle becomes smaller as the pitch of the teeth of the guide roller mounting gear 500 is decreased, in other words as the number of teeth is increased (or the gear has a larger diameter and the teeth are smaller).

(Method of Adjusting the Print Gap (the Space Between the Printing Unit 20 and Lower Casing Frame 101 (Platen)) Using the Print Gap Adjuster 50a)

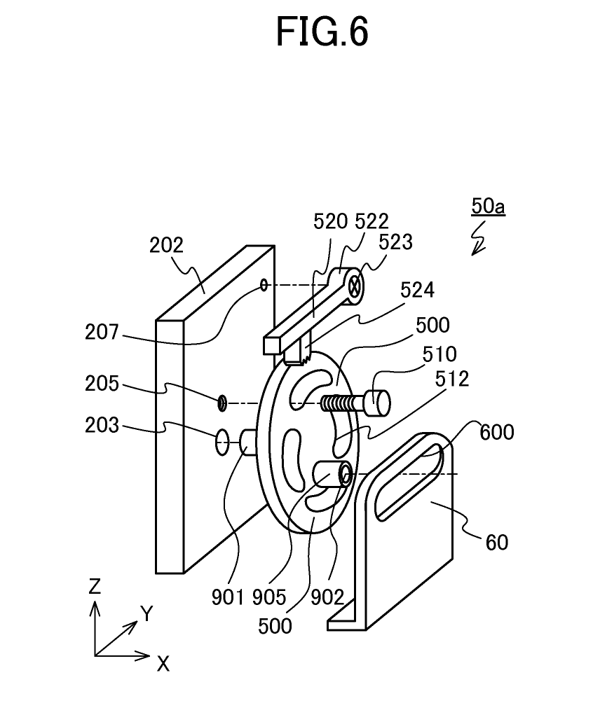

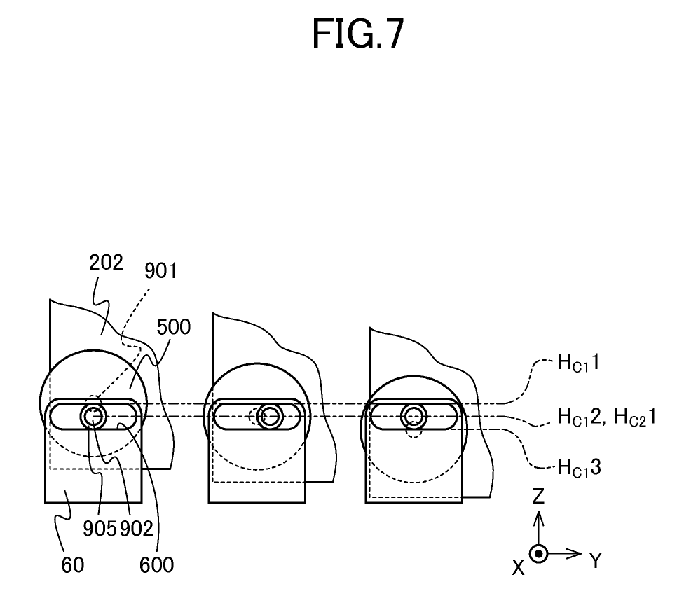

The print gap adjustment method using the above-described print gap adjuster 50a will be described hereafter with reference to FIGS. 6 and 7. Here, the scale in the figures is different from the actual scale for easier understanding. Particularly, the distance between the central shaft 901 and eccentric protrusion 902 (which corresponds to the magnitude of eccentricity and is equal to the distance between H_{C1}1 and H_{C2}1) is shown larger than the actual distance. The actual magnitude of eccentricity is approximately 0.2 mm at most. For example, when the magnitude of eccentricity is 0.2 mm, the print gap can be adjusted within a range from −0.2 mm to +0.2 mm.

First, a time recorder 10 comprising a printing unit 20, two guide roller mounting gears 500 rotatably supported by the printing unit 20, two guides 60 slidably supporting the two guide roller mounting gears 500, respectively, is prepared.

Then, a rotational force is applied to the guide roller mounting gear 500 so that the guide roller mounting gear 500 is released from the elastic contact with the gear fixing rack 520 and rotates.

As the guide roller mounting gear 500 rotates, the guide roller 905 rotates eccentrically with respect to the central shaft 901 that is the center of rotation along with the eccentric protrusion 902. As shown in FIG. 7, the guide roller 905 can move in the longitudinal direction within the range of the length of the guide groove 600; however, the guide roller 905 does not move in the vertical direction more than the clearance given for a capacity for sliding because of delimitation by the upper and lower edges of the guide groove 600.

Here, the guide 60 (having the guide groove 600) supporting the guide roller 905 is fixed on the lower casing frame 101 as described above. On the other hand, the printing unit 20 (having the hole 203) supporting the central shaft 901 is not fixed on the lower casing frame 101. In other words, as shown in FIG. 7, when the guide roller mounting gear 500 rotates, the guide roller 905 (eccentric protrusion 902) supported by the guide 60 does not move up or down with respect to the lower casing frame 101 (always stays at a height of H_{C2}1 in FIG. 7) and the central shaft 901 moves up or down with respect to the lower casing frame 101 (moves to a height of H_{C1}1, H_{C1}2, H_{C1}3, or the like in FIG. 7).

Consequently, the entire printing unit 20 on which the guide roller mounting gear 500 is mounted moves in the Z-direction. According to the amount of movement of the printing unit 20 in the Z-direction, the space (gap) between the printing unit 20 and lower casing frame 101 (platen) is changed.

Then, the guide roller mounting gears 500 on both sides are rotated so that the ends of the printing unit 20 in the X-direction are parallel to the top surface of the lower casing frame 101 and a desired space (print gap) between the printing unit 20 and lower casing frame 101 is obtained over the range in which the printing unit 20 is movable in the X-direction. Then, two fixing screws 510 are screwed in female screw holes 205 through the elongated holes 512 formed in the guide roller mounting gears 500 on both sides, respectively, to fix the guide roller mounting gears 500 to the lateral block frames 202, whereby the print gap adjustment is completed.

In the above-described print gap adjustment method, the carriage 210 comprising the ribbon reeling-up gears 216 and the ribbon reeling-up gear rack 300 move in one piece along with the printing unit 20. Therefore, upon the print gap adjustment, the positional relationship between the ribbon reeling-up gears 216 and ribbon reeling-up gear rack 300 does not change. In other words, the ribbon reeling-up gears 216 and ribbon reeling-up gear rack 300 do not move away from each other or are not released from the intermeshing state upon the print gap adjustment. Then, the print gap adjustment range can be increased. More specifically, using the eccentric protrusion 902 largely spaced from the central shaft 901, the print gap adjustment range can be increased.

Here, the gap adjustment is conducted at the factory, not conducted by the user. Therefore, the distance between the head lower end and the print sheet upper end changes depending on the print sheet thickness. The gap adjustment is conducted in consideration for such change and no problem will occur as long as a sheet of a thickness in an anticipated range is used.

(Longitudinal Driver 42 of the Printing Unit 20)

The longitudinal driver 42 making the printing unit 20 movable in the Y-direction will be described hereafter with reference to FIGS. 1 to 3.

The longitudinal driver 42 mainly comprises a deceleration gear group 421, a motor 420 rotating the deceleration gear group 421 according to the control of the controller 800, a rotation shaft 430 rotating in association with the rotation of the deceleration gear group 421, and a gear 428 fixed to the circumference of the rotation shaft 430.

The motor 420 has a rotation shaft rotatable both forward and backward and is fixed to the second lateral casing frame 104. A pinion (input gear) 422 is fixed to the rotation shaft of the motor 420.

The deceleration gear group 421 is rotatably supported by the second lateral casing frame 104 and comprises the pinion 422, an intermediate gear 424 intermeshing with the pinion 422, and an output gear 426 intermeshing with the intermediate gear 424.

The intermediate gear 424 has a larger diameter and a greater number of teeth than the pinion 422. With the pinion 422 intermeshing with the intermediate gear 424, the rotation speed of the rotation shaft of the motor 420 is reduced.

The output gear 426 has a D-shaped center hole at the center, in which the rotation shaft 430 is fitted. In other words, the rotation of the intermediate gear 424 causes the rotation shaft 430 to rotate via the output gear 426.

Running through the elongated holes 242 formed in the lateral block frames 202 on both sides, the rotation shaft 430 extends through the printing unit 20 in the X-direction. The gears 428 intermeshing with the longitudinal racks 240 are fixed on the circumference of the rotation shaft 430 protruding from the lateral block frames 202 at both ends.

(Motion of the Longitudinal Driver 42 of the Printing Unit 20)

The motion of the longitudinal driver 42 having the above structure will be described hereafter. According to the control of the controller 800, the rotation shaft of the motor 420 rotates either forward or backward. First, as the rotation shaft of the motor 420 rotates forward (the rotation direction causing the pinion 422 to rotate clockwise in FIGS. 1 and 2), the rotative power is transferred to the pinion 422, deceleration gear group 421, rotation shaft 430, and gear 428 in sequence, whereby the gear 428 rotates forward. Furthermore, since the gear 428 and longitudinal rack 240 intermesh with each other, the rotative power of the gear 428 is converted to a motive power to move the printing unit 20 in the +Y-direction. In this way, as the rotation shaft of the motor 420 rotates forward, the printing unit 20 moves in the +Y-direction.

On the other hand, as the rotation shaft of the motor 420 rotates backward (the rotation direction causing the pinion 422 to rotate counterclockwise in FIGS. 1 and 2), the rotative power is transferred to the pinion 422, deceleration gear group 421, rotation shaft 430, and gear 428 in sequence, whereby the gear 428 rotates backward. Furthermore, since the gear 428 and longitudinal rack 240 intermesh with each other, the rotative power of the gear 428 is converted to a motive power to move the printing unit 20 in the −Y-direction. In this way, as the rotation shaft of the motor 420 rotates backward, the printing unit 20 moves in the −Y-direction.

Since the printing unit 20 moves in the print sheet feed direction (Y-direction) according to the instruction of the controller 800 as described above, only the space for the printing unit 20 to move in the print sheet range is required and the space necessary for the print sheet to move in the Y-direction can be reduced compared with a device in which the printing unit 20 is immovable. Consequently, the entire time recorder 10 can be downsized.

### Modified Embodiment 1

The above-described print gap adjuster 50a comprises a guide 60 having a guide groove 600 in the shape of an elongated hole, a guide roller mounting gear 500 to which a guide roller 905 is attached in the manner that the guide roller 905 is slidably supported by the guide groove 600, and a lateral block frame 202 rotatably supporting the central shaft 901 of the guide roller mounting gears 500 via a hole 203. The present invention is not confined to this structure.

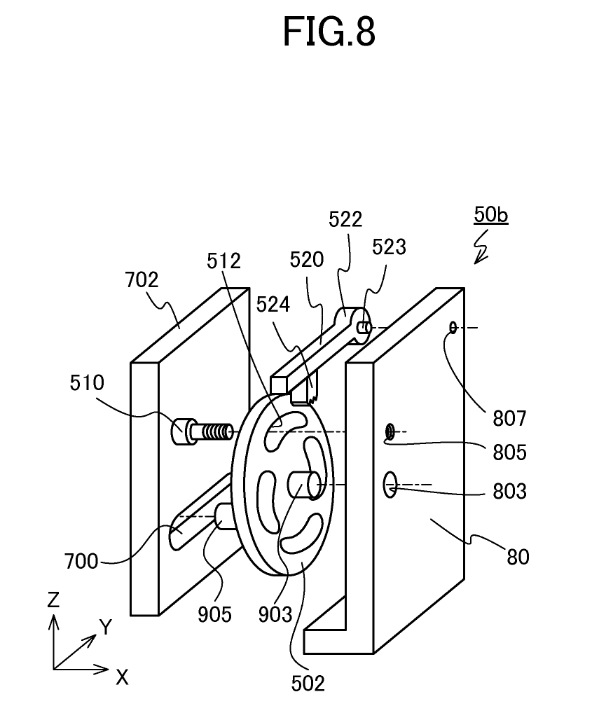

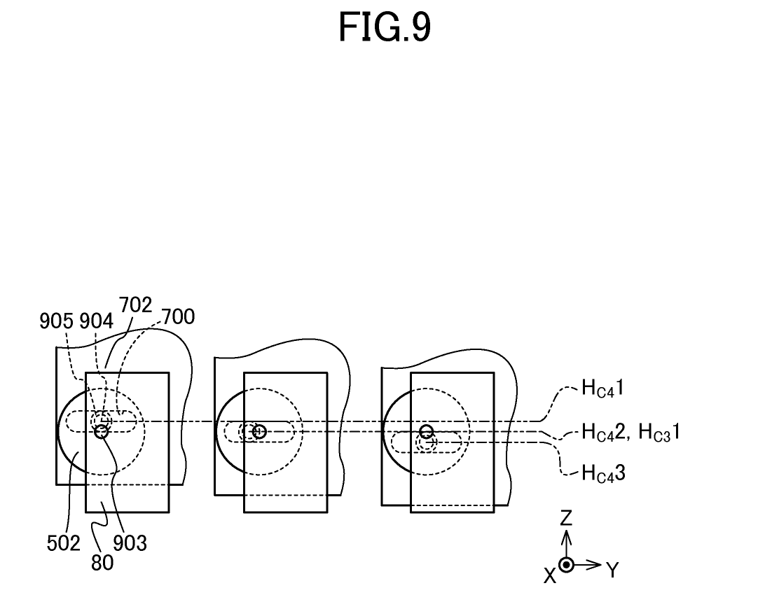

For example, the supportive relationship between the guide 60 and guide roller 905 and the supportive relationship between the central shaft 901 and lateral block frame 202 can be interchanged in combination. A print gap adjuster 50b according to Modified Embodiment 1 having such a structure will be described hereafter with reference to FIGS. 8 and 9. Here, the components having nearly the same function and structure as those of the time recorder 10 according to the above-described embodiment are referred to by the same reference numbers and their explanation is omitted for clarifying the difference.

The print gap adjuster 50b according to Modified Embodiment 1 comprises a third lateral casing frame 80 fixed on the lower casing frame 101, a guide roller mounting gear 502, a lateral block frame 702 that is a part of the printing unit 20, and a gear fixing rack 520. Two sets of these components are provided to the right and to the left of the printing unit 20 symmetrically. The components of the print gap adjuster 50b will be described in detail hereafter.

The two third lateral casing frames 80 extend in the Y-Z plane, are nearly in parallel to each other, and each have a through-hole 803 formed for supporting a central shaft 903 described later and a female screw hole 805 in which a fixing screw 510 is screwed. A guide roller mounting gear 502 is provided on the surface of the two third lateral casing frames 80 that faces the lateral block frame 702 described later. A central shaft 903 in the shape of a protrusion formed on the guide roller mounting gear 502 is rotatably supported by the hole 803. Here, the hole 803 is not limited to a through-hole and can be a recess-like hole as long as the hole 803 can rotatably support the guide roller mounting gear 502.

The guide roller mounting gear 502 is a spur gear having an eccentric protrusion 904 formed at a position shifted from the center of rotation (an eccentric position) and protruding from the first surface (the surface facing the lateral block frame 702), a central shaft 903 formed at the center of rotation and protruding from the second surface (the surface facing the third lateral casing frame 80), and four arc-shaped elongated holes 512 provided evenly on a concentric circle around the central shaft 903.

With the central shaft 903 being inserted in the hole 803, the guide roller mounting gear 502 is supported by the third lateral casing frame 80 (the casing 100 including it) rotatably about the hole 803. A guide roller 905 is rotatably supported around the eccentric protrusion 904. The eccentric protrusion 904 and guide roller 905 are inserted in a guide groove 700 of the lateral block frame 702 described later. Upon print gap adjustment described later, the guide roller 905 is supported by the guide groove 700 slidably in the Y-direction and abuts against the edges of the guide groove 700 in the Z-direction to move the printing unit 20 up or down. Furthermore, when the printing unit 20 moves in the Y-direction, the guide roller 905 makes sliding contact with the guide groove 700; then, the printing unit 20 moves in the Y-direction smoothly while maintaining its height in the Z-direction. Furthermore, with a fixing screw 510 being screwed in the female screw hole 805 after the print gap adjustment, the guide roller mounting gear 500 is fixed to the third lateral casing frame 80.

The two lateral block frames 702 extend in the Y-Z plane, are nearly parallel to each other, and each have a guide groove 700 in the shape of an elongated hole of which the longitudinal direction coincides with the Y-direction. Upon the print gap adjustment, the guide groove 700 supports the central shaft 904 formed on the guide roller mounting gear 502 and the guide roller 905 slidably in the Y-direction.

The base end 522 of the gear fixing rack 520 is fixed to (supported by) the outer surface of the third lateral casing frame 80 by a screw 523.

(Print Gap Adjustment Method Using the Print Gap Adjuster 50b)

The print gap adjustment method using the above-described print gap adjuster 50b will be described hereafter with reference to FIGS. 8 and 9.

First, a time recorder 10 comprising two third lateral casing frames 80, two guide roller mounting gears 502 rotatably supported by the two third lateral casing frames 80, respectively, and a printing unit 20 slidably supporting the two guide roller mounting gears 502 is prepared.

Then, a rotational force is applied to the guide roller mounting gear 502 so that the guide roller mounting gear 502 is released from the elastic contact with the gear fixing rack 520 and rotates.

As the guide roller mounting gear 502 rotates, the guide roller 905 rotates eccentrically with respect to the central shaft 903 that is the center of rotation along with the eccentric protrusion 904. As shown in FIG. 9, the guide roller 905 can move in the longitudinal direction within the range of the length of the guide groove 700; however, the guide roller 905 does not move in the vertical direction more than the clearance given for a capacity for sliding because of delimitation by the upper and lower edges of the guide groove 700.

Here, the third lateral casing frame 80 (having the hole 803) supporting the central shaft 903 is fixed on the lower casing frame 101 as described above. On the other hand, the printing unit 20 (lateral block frame 702) (having the guide groove 700) supporting the guide roller 905 is not fixed on the lower casing frame 101. In other words, as shown in FIG. 9, when the guide roller mounting gear 502 rotates, the central shaft 903 does not move up or down with respect to the lower casing frame 101 (always stays at a height of H_{C3}1 in FIG. 9) naturally because the third lateral casing frame 80 is fixed on the lower casing frame 101 and the central shaft 903 is supported by the third lateral casing frame 80. On the other hand, the guide roller 905 (eccentric protrusion 904) is eccentric to the central shaft 903 that is the center of rotation and moves on a concentric circle having a radius equal to the intercentral distance between the guide roller 905 and central shaft 903. In FIG. 9, the height of the guide roller 905 with respect to the lower casing frame 101 changes to H_{C4}1, H_{C4}2, H_{C4}3, or the like.

Consequently, the entire printing unit 20 (comprising the lateral block frame 702) having the guide groove 700 abutting in the Z-direction moves in the Z-direction as much as the amount of movement in the Z-direction of the guide roller 905. According to the amount of movement in the Z-direction of the printing unit 20, the space (gap) between the printing unit 20 and lower casing frame 101 (platen) is changed.

Then, the guide roller mounting gears 502 on both sides are rotated so that the ends (lateral block frames 702) of the printing unit 20 are parallel to the top surface of the lower casing frame 101 and a desired space (print gap) to the lower casing frame 101 is obtained. Then, two fixing screws 510 are screwed in the female screw holes 805 through the elongated holes 512 formed in the guide roller mounting gears 502 on both sides, respectively, to fix the guide roller mounting gears 502 to the third lateral casing frames 80, whereby the print gap adjustment is completed.

In the above-described print gap adjustment method, the printing unit 20 comprising the carriage 210 incorporating the ribbon reeling-up gears 216 and the ribbon reeling-up gear rack 300 moves along with these components in one piece. Therefore, upon the print gap adjustment, the positional relationship between the ribbon reeling-up gears 216 and ribbon reeling-up gear rack 300 does not change. In other words, the ribbon reeling-up gears 216 and ribbon reeling-up gear rack 300 do not move away from each other or are not released from their intermeshing state upon the print gap adjustment. Then, the print gap adjustment range can be increased while keeping the ribbon reeling-up gears 216 and ribbon reeling-up gear rack 300 intermeshing with each other well. More specifically, using the eccentric protrusion 904 largely spaced from the central shaft 903, the print gap adjustment range can be increased.

Incidentally, the print gap adjustment is conducted while the product is assembled, not conducted by the user. Therefore, the distance between the head lower end and the print sheet upper end changes depending on the print sheet thickness. The gap adjustment is conducted in consideration for such change and no problem will occur as long as a sheet of a thickness in an anticipated range is used.

### Modified Embodiment 2

In the above-described structure, the edges of the guide groove 700 (of the lateral block frame 702) abut against the guide roller 905 (of the guide roller mounting gear 502) in the Z-direction. However, the present invention is not confined to this structure.

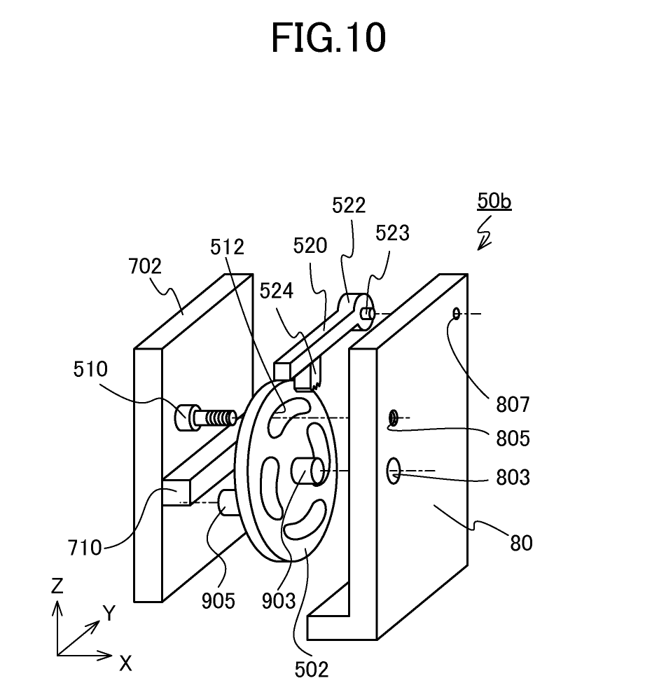

More specifically, it is sufficient that the guide roller mounting gear 502 abuts against the lateral block frame 702 in the Z-direction and is slidable in the Y-direction. For example, as shown in FIG. 10, a protrusion 710 protruding in the +X-direction and extending in the Y-direction can be used. In such a case, in order for the guide roller 905 to be driven, the protrusion 710 has an underside abutting against the guide roller 905. With this structure, upon the print gap adjustment, as the guide roller 905 eccentrically rotates, the printing unit 20 moves up or down while the protrusion 710 is always in contact with the guide roller 905 due to the self-weight of the printing unit 20. In other words, the position of the printing unit 20 can be adjusted according to the position of the guide roller 905.

The above structure comprising the protrusion 710 instead of the guide groove 700 can be applied to the guide groove 600 according to the above-described embodiment. In such a case, as described above, in order for the guide roller 905 to be driven, the protrusion has a top surface abutting against the guide roller 905.

Here, in the above-described embodiment, the guide roller mounting gear 500 is rotatably supported by the lateral block frame 202 with the central shaft 901 inserted in the hole 203. However, this structure is not restrictive. For example, the protrusion and the hole supporting the protrusion can be reversed in position as long as the guide roller mounting gear 500 is rotatable relatively with respect to the lateral block frame 202. More specifically, it is possible to provide the lateral block frame 202 with a protrusion and fit the protrusion in the center hole of the guide roller mounting gear 500 so that the guide roller mounting gear 500 is rotatably supported.

Furthermore, as for the central shaft 903 of the guide roller mounting gear 502 and the hole 803 of the third lateral casing frame 80 according to Modified Embodiment 1, the protrusion and the hole supporting the protrusion can similarly be reversed in position.

As described above, in the print gap adjustment with the time recorder 10 according to the embodiment, the entire printing unit 20 can be moved up or down by rotating the guide roller mounting gears 500 or 502. Therefore, the intermeshing between the rack and gears within the printing unit 20 can stably be maintained.

Furthermore, the guide roller mounting gear 500 is provided at both ends of the printing unit 20. Then, the tilt of the printing unit 20 in the horizontal direction can easily be corrected to obtain a uniform print gap by rotating the right and left guide roller mounting gears 500 by different amounts of rotation.

Furthermore, provision of the guide roller 905 rotatably supported by the eccentric protrusion 902 or 904 prevents occurrence of friction while the printing unit 20 moves up or down, which facilitates the print gap adjustment. Furthermore, the guide roller 905 rotates as the printing unit 20 moves in the longitudinal direction; then, the guide roller 905 has the function of allowing the printing unit 20 to move smoothly in the longitudinal direction.

Furthermore, the gear fixing rack 520 in elastic contact with the teeth of the guide roller mounting gear 500 or 502 gives the worker a sense of clicking and maintains the guide roller mounting gear 500 or 502 at a given rotation angle. Therefore, setting to a desired angle is facilitated. In other words, the print gap adjustment is facilitated.

Furthermore, the longitudinal driver 42 driving the printing unit 20 in the longitudinal direction allows the printing unit 20 to move actively with respect to the print sheet. Consequently, the space for accommodating the print sheet can be reduced and the time recorder can be downsized.

Furthermore, with the longitudinal driver 42, the motor 220 rotates the rotation shaft 430 and the gears 428 fixed to the rotation gear 430 via the deceleration gear group 421, whereby the printing unit 20 moves in the longitudinal direction via the longitudinal racks 240 intermeshing with the gears 428. The rotation shaft 430 runs through the elongated holes 242 formed on both sides of the printing unit 20 and the gears 428 and longitudinal racks 240 intermesh with each other on both sides outside the elongated holes 242.

With the above structure, the printing unit 20 can be moved in parallel in the longitudinal direction by means of the motor 220 and deceleration gear group 421 provided only on one side; the number of components can be decreased.

The present invention is specifically described above based on embodiments. The present invention is not confined to the above-described embodiments and various modifications can be made without departing from the gist thereof.

For example, in the above explanation, the guide roller mounting gear 500 has spur teeth on the circumference. Besides the spur teeth, multiple protrusions or recesses can be provided as long as they intermesh (engage) with the leading end 524 of the gear fixing rack 520 at a given pitch.

Furthermore, in the above explanation, the gear fixing rack 520 is made of an elastic material and is in elastic contact with the guide roller mounting gear 500. This structure is not restrictive as long as the gear fixing rack 520 can engage with the guide roller mounting gear 500. For example, it is possible that the gear fixing rack is rotatably supported by, not fixed to, the lateral block frame or third lateral casing frame, and a coil spring is fixed to the gear fixing rack and to the lateral block frame or third lateral casing frame. In such a case, the gear fixing rack does not need to be made of an elastic material and the engagement between the gear fixing rack and guide roller mounting gear 500 can be maintained by a given force from the restoring force of the coil spring.

Furthermore, the time recorder according to the present invention can exclude a gear fixing rack and comprise a guide roller mounting gear having no spur teeth on the circumference as long as the printing unit can move in the vertical direction for print gap adjustment. In other words, the function of setting the minimum adjustment amounts of the height and inclination of the printing unit is provided on an arbitrary basis.

### INDUSTRIAL APPLICABILITY

In the above described embodiments, the present invention is applied to a dot impact time recorder by way of example. The present invention is applicable to a thermal-transfer counterpart. Furthermore, the present invention can be used with printers, fax machines, and other printing devices.

Various embodiments and modifications are available to the present invention without departing from the broad sense of spirit and scope of the present invention. The above-described embodiments are given for explaining the present invention and do not confine the scope of the present invention. In other words, the scope of the present invention is set forth by the scope of claims, not by the embodiments. Various modifications made within the scope of claims and scope of significance of the invention equivalent thereto are considered to fall under the scope of the present invention.

The present invention is based on Japanese Patent Application No. 2012-010979, filed on Jan. 23, 2012, and the entire specification, scope of claims, and drawings of which are incorporated herein by reference.

### REFERENCE SIGNS LIST

10 Time recorder (printing device)
100 Casing
101 Lower casing frame (platen)
20 Printing unit
204 X-direction guide rod
210 Carriage
214 X-direction rack
215 Ink ribbon
216 Ribbon reeling-up gear
220 Motor
224 Two-step gear
240 Longitudinal rack (second-direction rack)
242 Elongated hole
300 Ribbon reeling-up gear rack
420 Motor
421 Deceleration gear group
422 Pinion (input gear)
428 Gear (first gear)
430 Rotation shaft
50a, 50b Print gap adjuster
500, 502 Guide roller mounting gear
520 Gear fixing rack
600, 700 Guide groove
710 Protrusion
800 Controller
901, 903 Central shaft
902, 904 Eccentric protrusion (eccentric shaft)
905 Guide roller

1. A printing device, comprising:
a casing comprising first gears rotatably supported by the casing and a motor rotating the first gears;
a printing unit provided within the casing and comprising a carriage provided slidably in a first direction and comprising a print head and second-direction racks extending in the second direction perpendicular to the first direction and to the print direction and intermeshing with the first gears; and
a controller controlling the motor.

2. The printing device according to claim 1, wherein
the printing unit comprises a rotation shaft extending in the first direction;
the first gears are fixed to both ends of the rotation shaft coaxially;
the second-direction racks are provided on both sides of the printing unit in the first direction and intermesh with the first gears, respectively; and
the motor rotates the rotation shaft so as to rotate the first gears.

3. The printing device according to claim 2, wherein
the printing unit has elongated holes at both ends that are formed through in the first direction and of which the longitudinal direction coincides with the second direction; and
the rotation shaft is provided through the elongated holes.

4. The printing device according to claim 2, wherein
the rotation shaft is fixed to one gear in a gear group comprising multiple intermeshing gears; and
the motor rotates the input gear that is another gear in the gear group so as to rotate the rotation shaft.

5. The printing device according to claim 1, wherein
the printing unit comprises a reeler comprising a reeling-up rack extending in the first direction, reeling-up gears intermeshing with the reeling-up rack and rotating as the carriage moves in the first direction, and a reeling-up shaft reeling up the ink ribbon of the printing head as the reeling-up gears rotate; and
the reeler is mounted in the casing movably in the print direction in one piece with the print head.

6. The printing device according to claim 5, comprising:
a guide formed on one of the printing unit and casing and extending in the direction perpendicular to the print direction;
a gap adjustment member comprising a central shaft supported by the other of the printing unit and casing and an eccentric shaft provided with its shaft center shifted from the central shaft and moving as guided by the guide; and
a fixing member fixing the gap adjustment member to the casing so that the gap adjustment member is not rotatable.
